(19) United States
(12) Patent Application Publication
(10) Pub. No.: US 2004/0148439 A1
(43) Pub. Date: Jul. 29, 2004

(54) Apparatus and method for peer to peer network connectivty

(75) Inventors: George Harvey, Bedford, MA (US); Ying-Leh Lin, Franklin, MA (US); Patrick Maurer, Wayland, MA (US)

Correspondence Address: FITCH EVEN TABIN AND FLANNERY, 120 SOUTH LA SALLE STREET, SUITE 1600, CHICAGO, IL, 60603-3406, US

(73) Assignee: Motorola, Inc.

(21) Appl. No.: 10/341,681

(22) Filed: Jan. 14, 2003

(51) Int. Cl. G06F 15/16

(52) U.S. Cl. 709/249

(57) ABSTRACT

A system and method for creating a peer to peer network by interconnecting private networks via publicly addressable residential gateways. A tunnel between a gateway of a first private network and a gateway of a second private network is established and the address of a device in one of the private networks is mapped into the other private network for enabling the device in one of the private networks to communicate with the other private network. Interconnection between private networks is enabled where the private networks and connected devices are able to communicate among themselves without changes to the host system or a need for a centralized server in the public network. Security is provided through the use of Internet Protocol Security (IPsec).

### FIELD OF THE INVENTION

The present invention relates generally to IP based networking and, more particularly, to connectivity between multiple private networks.

### BACKGROUND OF THE INVENTION

Interconnecting multiple personal computers (PC) and other devices together to form a small private network is an increasingly popular practice, especially within the home and with small to medium sized businesses. This enables the devices to communicate with one another and enables sharing of resources. In addition, private networks may share files with others who are outside the private network and access a public network, such as the Internet, typically through a single primary connection to the Internet. The connection may be cable, satellite, DSL, dial-up, wireless or other access method. An often-exploited benefit of such a single primary connection is the insertion of a residential gateway (RG) 10 between the public Internet and private network, which provides a single, controllable point of contact between the two networks.

As shown in FIG. 1, an RG 10 is a commonly used device for connecting a private network having several devices, such as a PC 12, printer 14 and telephone 16, for example, to the Internet 18. Typically, the residential gateway 10 includes a conventional form of Network Address Translation (NAT) and/or Network Address and Port Translation (NAPT) functions, firewall, Dynamic Host Configuration Protocol (DHCP) server, Domain Name System (DNS) server, bridging and other services. The RG 10 and its components may be implemented in hardware, software or a combination of both.

NAT enables multiple computers or devices on a private network to access the Internet using only a single IP address since the number of globally unique IP addresses available is usually limited, particularly so in a residential setting. Although NAT/NAPT is usually sufficient for devices within the private network to initiate sessions with outside systems, the reverse is not easily accommodated since NAT maps a small set (usually only one) of globally unique, publicly routable IP addresses to at least as many private IP addresses in the private network, usually in a time-varying manner. This results in NAT effectively preventing incoming connections, as the publicly routable IP address does not always map to the same device in the private network, and often even maps to multiple devices via different ports. As such, sharing access to the respective private networks, and the connected devices in remote locations, of friends, family and others becomes difficult when using NAT. Additionally, sessions initiated outside the gateway are typically blocked, as allowing them presents a major security risk.

Peer-to-peer (P2P) networking is one method that attempts to enable communications between private networks. Participants, such as private networks, in a P2P network typically share a part of their own hardware resources, such as processing power, storage capacity, network link capacity or printers, and a part of their data.

Currently popular P2P networks, like many of those based in whole or in part on the well-known and widely-used Gnutella network, have a number of disadvantages. As shown in FIG. 2, many P2P networks require a server 20 in the public network for connecting the private networks 22, 24, which may be behind a residential gateway 10, 10′. Typically, such P2P services are advertising or fee driven, have a limited set of operations and functions, require each participating device to have a globally unique, publicly routable IP address, and require software to be added to systems that wish to participate. Security is also a concern when using P2P networks. For example, P2P-enabled devices must be visible to and accessible from the public Internet for searching and retrieval of files.

For enhanced security, enterprises use virtual private networks (VPN) for secure remote access communications among sites. However, these sites require a single administrative domain that assures that there are no address conflicts.

### BRIEF DESCRIPTION OF THE DRAWINGS

FIG. 1 is a schematic diagram of a previously known typical private network using NAT for Internet access;

FIG. 2 is a schematic diagram of a previously known P2P network;

FIG. 3 is a schematic diagram of a pair of private networks in P2P communication in accordance with an embodiment of the invention;

FIG. 4 is a schematic diagram of a pair of private networks in a P2P configuration in accordance with an embodiment of the invention;

FIG. 5 is a block diagram of a residential gateway in accordance with an embodiment of the invention.

FIG. 6 is a schematic diagram illustrating the operation of establishing and transmitting packets in a P2P network in accordance with an embodiment of the invention.

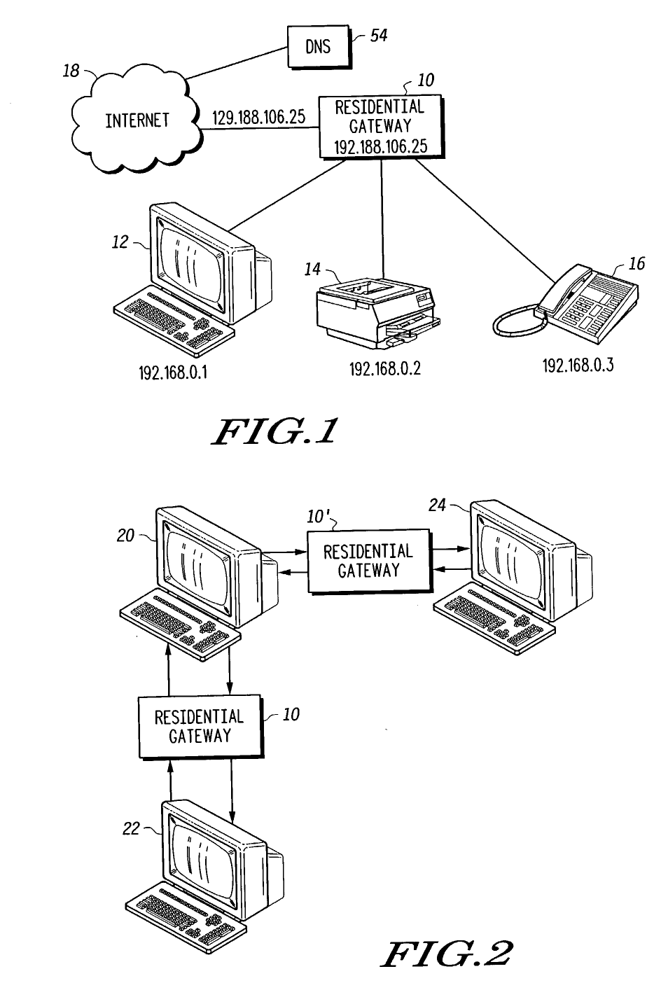

### DETAILED DESCRIPTION

In order to address the need for interconnecting private networks via residential gateways and others, a tunnel between a gateway of a first private network and a gateway of a second private network is established and the address of a device in one of the private networks is mapped into the other private network for enabling the device in one of the private networks to communicate with the other private network. As such, interconnection between private networks is enabled where the private networks and connected devices are able to communicate among themselves without changes to the host system or a need for a centralized server in the public network. Security is provided through the use of Internet Protocol Security (IPsec) or a similar mechanism. A particular advantage of the P2P network system described herein is its ability to operate in a substantially transparent manner. For example, devices in different homes (on different networks) are able to communicate as though they are in the same home (on the same network) and applications execute unchanged. Additionally, the system is automated to enable fast and efficient recovery from network failures and IP address changes. Furthermore, each private or home network remains independent and each peer has complete access control. Security and privacy concerns are mitigated to a large degree since private network access is likely to be given only to trusted remote private networks.

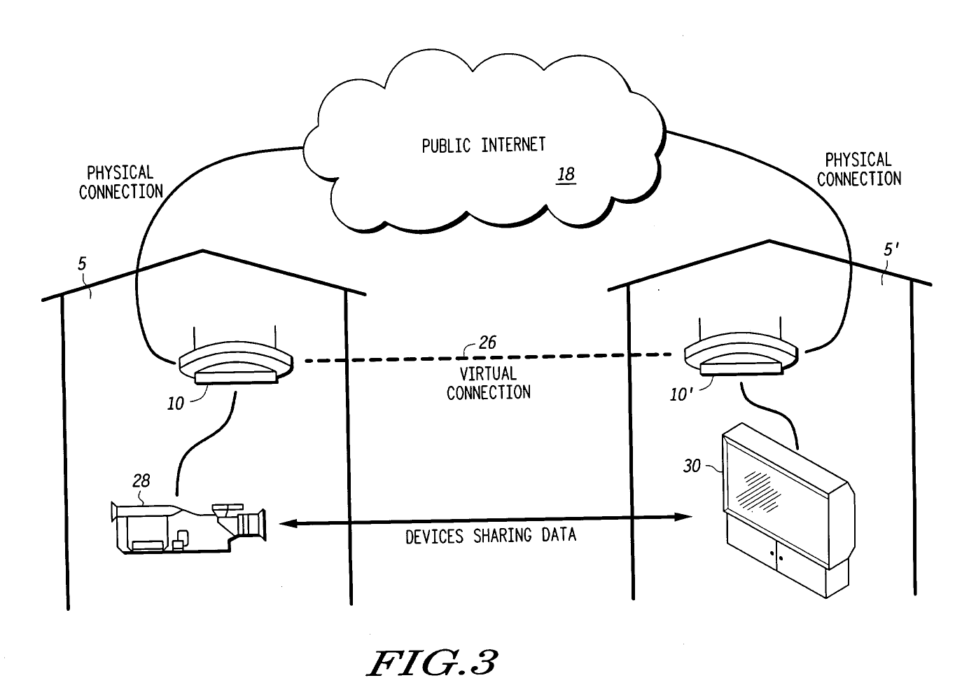

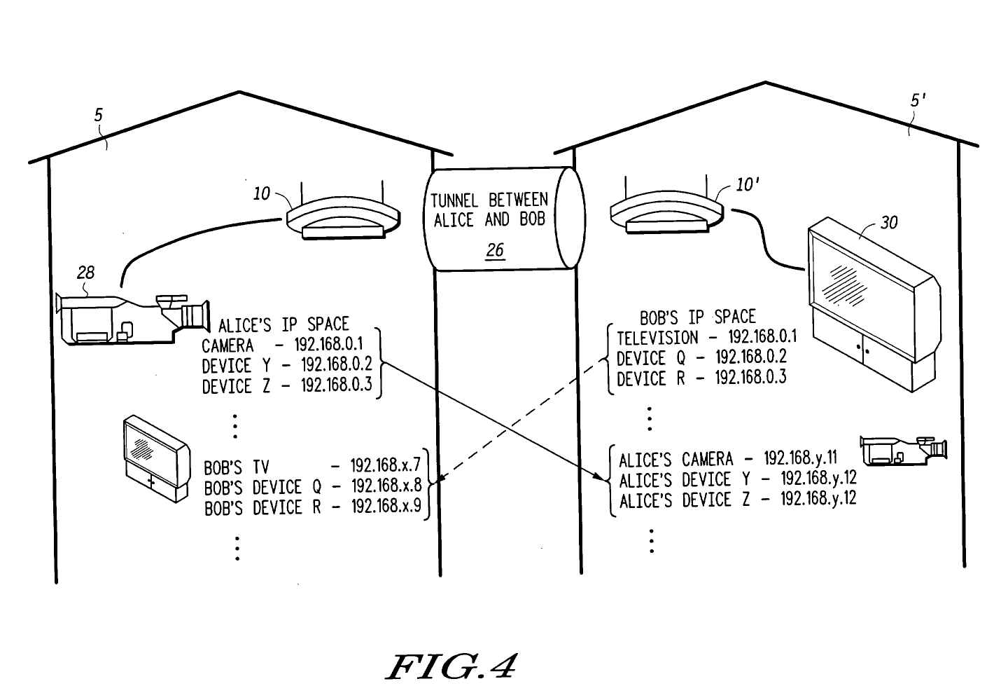

FIG. 3 shows, by way of example, a pair of homes 5, 5′ that enable mutual access to each other's network by establishing a secure tunnel 26 through the public network 18 that connects their respective RGs 10, 10′. Because each RG 10, 10′ has a public IP address, either RG 10, 10′ can find the other using the public directory service (usually DNS). After at least one RG 10 has discovered the IP address of a peer RG 10′, it can establish the tunnel 26 to that peer. If the RGs 10, 10′ share a secret, the tunnel 26 can be made secure. Once the tunnel 26 is established, a locally located video camera 26, for example, can transmit pictures to a remotely located television 30. It is to be noted, and as further discussed below, that the number of peers that may be connected in the P2P network is virtually unlimited.

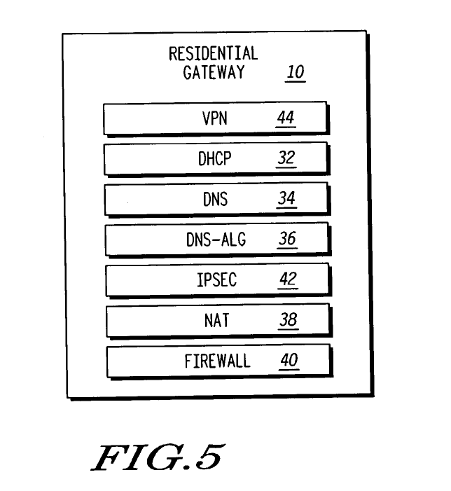

As shown in FIG. 4, the RGs 10, 10′ maps the addresses of devices in their respective remote peer's address space to unused addresses in their own private address space and vice versa. This allows the devices, such as the camera 28 and the television 30, in each private network or home to communicate using existing applications without adding special software.

Each RG 10, 10′ is provided the ability to enforce access control policies on a per tunnel basis so that only those devices, applications and other resources that the administrator of the home specifies are visible to the specific peer.

FIG. 5 shows the RG 10 having a number of built in functions that are used for connecting a private or home network to the public Internet. Although there is no single definition of the type of functionality that must be provided in the RG 10, there is typically provided DHCP 32, DNS 34, DNS Application Layer Gateway (DNS-ALG) 36, NAT 38, Firewall 40, IPsec 42 and VPN 44 functions. Fewer or greater functions and/or applications may be provided in the RG 10 as needed.

The VPN 44 enables mutual access between networks by establishing a secure tunnel through the Internet between residential gateways. Several styles of VPN are possible. For example, MAC frames could be bridged between homes (known as VPLS). This has the virtue of allowing multiple protocols to flow between the private networks. In a particular exemplary embodiment, to ensure that no conflicts arise, such as where each private network independently assigns IP addresses from the private address space that could possibly result in duplicate IP addresses between the homes, tunneling of IP packets only (known as a “Virtual Private Routed Network”, or VPRN) is allowed. Other tunneling methods that ensure conflict-free operation may be used as well. IPsec 42, along with Internet Key Exchange (IKE), are the protocols used to automatically recover if communications fails and to ensure that the VPN network tunnel is secure, thereby protecting traffic between two private systems. Other methods of establishing secure communications channels also may be used instead.

NAT 38 enables multiple systems, for example in a home, to communicate outside the home and is used when a network's internal IP addresses cannot be used outside the network either because they are invalid for use outside, or because the internal addressing must be kept private from the external network. A variation of NAT called network address port translation (NAPT) translates UDP, TCP port numbers as well as IP addresses. Thus, many private hosts may be supported with just a single public IP number. In the described exemplary embodiment, an enhanced NAT 38 protocol is used to set up VPN specific mappings such that the address space of a remote peer is mapped into a local address space. A particular advantage of such a configuration is that port mapping is not required and that each peer can have different security policies.

The public DNS 54 (FIG. 1) translates domain names (like motorola.com) into IP addresses (like 129.188.106.25) and is used to obtain the globally available IP addresses of the private network gateways. Every time a domain name is used, the DNS server translates the name into its corresponding IP address. The local DNS 34 operates similarly, but is used in the described embodiment within the local network to store entries relating to addresses of the private networks, particularly when a tunnel is established between private networks.

The DNS-ALG 36 transparently intercepts the DNS 34 query and replaces the remote 38 generated address with one that is properly routable in the local private network and vice versa. This is done as DNS packets are transmitted and received between the private and public networks. As used in the described exemplary embodiment, once a tunnel is established between private networks, the DNS-ALG 36 entries associate the public DNS addresses of the private networks with their respective appropriate tunnel identifiers and provide mapped addresses on lookup. Stated differently, the DNS/DNS-ALG response to a DNS query from inside the local network or from the other side of a connected tunnel is the same, and is a locally routable private address. If the query arrived through a tunnel, the response is passed back through that tunnel. The DNS-ALG on the remote side of the tunnel may then intercept the response and translate the response address content into yet another address, this time locally routable within the remote network.

DHCP is a protocol for dynamically assigning IP addresses to networked computers. Using DHCP, a computer is automatically given a unique IP address selected from a master list by a DHCP server each time the computer connects to a network. As described in the exemplary embodiment, the DHCP 32 adds or updates local addresses in the DNS 34. In particular, the DHCP 32 server assigns an address from within the local IP address space and creates a corresponding entry in the local DNS 34.

The firewall 40 operates like known firewalls where typically there is allowed different filtering behavior on a per port basis. Since each of the VPN tunnels is logically equivalent to a port, different firewall policies can be established for each tunnel. The two sides of each tunnel retain the behavioral properties of a single network. As such, refinement of security and privacy policies (such as at the application layer) more fine-grain than per-tunnel policies can still be achieved by traditional means.

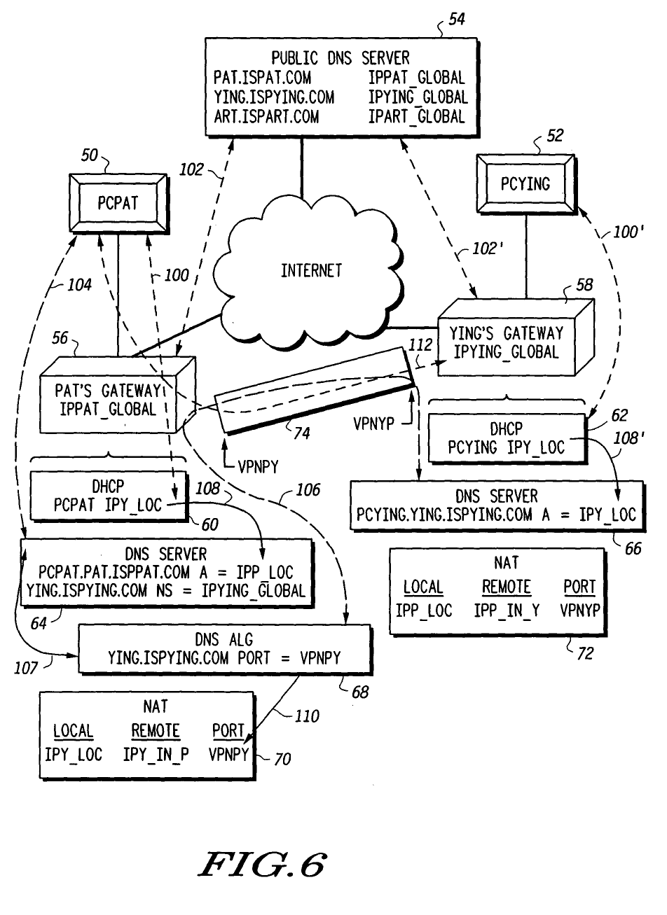

FIG. 6 illustrates an exemplary embodiment and operation of a P2P network created from a pair of private networks, such as in the home. Each of the private networks 50, 52 is assigned a global IP address and a Fully Qualified Domain Name (FQDN) as shown in Table 1. Each FQDN can be looked up in the globally reachable DNS name space using a public DNS server, such as DNS 54. It is to be understood that in actual operation, and as described below, the number of private networks is not limited to the examples given herein.

TABLE 1

| | | |
|---|---|---|
| Home | FQDN | Global address |
| Patrick | Pat.ISPpat.com | IPpat_global |
| Ying | Ying.ISPying.com | IPying_global |
| Art | Art.ISPart.com | IPart_global |

In each home or private network 50, 52 are devices that have the FQDNs of PCpat.Pat.ISPpat.com, PCying.Ying.ISPying.com, and PCart.Art.ISPart.com. In each home 50, 52, these devices each send a DHCP request 100, 100′ to the DHCP server 56, 62 in that home's RG 56, 58. Each request includes the FQDN of the device. It should be noted that conversion from other naming methods, incomplete names, or user interfaces to the FQDN is possible, and known good techniques exist. The DHCP servers 60, 62 assign addresses from the local IP address space and send a message 108, 108′ instructing the local DNS servers 64, 66 to create an entry in the form:

PCpat.Pat.ISPpat.com A=IPp_loc

PCying.Ying.ISPying.com A=Ipy_loc

PCart.Art.ISPart.com A=IPa_loc.

Suppose Pat and Ying, and Pat and Art agree to share networks, but no agreement exists between Ying and Art. Pat, Ying and Art must all set the policy in their respective gateways to reflect these agreements. As shown, either or both the RGs 56, 58 of Pat and Ying send a message 102, 102′ to find each other's global IP address in the publicly accessible DNS server 54. The same step is taken by gateways of Pat and Art (not shown). It will be appreciated that other embodiments of this information transfer mechanism exist; for example, by sending a marked e-mail message from one user to another, which is generated largely by the first gateway, and then intercepted by the second gateway. Another, non-automated and less robust method is for the owners of the two networks to communicate such information to one another and set parameters in their gateways manually.

The RGs 56, 58 of Pat and Ying set up an IPsec VPN tunnel 74 using IKE. Pat's gateway labels the tunnel VPNpy, and Ying's labels it VPNyp. Similarly, Pat and Art's RGs set up a VPN and label it, respectively, VPNpa and VPNap. Once the VPNs are established, a message 107 is sent between the local DNS 64 and the DNS_ALG 68 such that entries are made in the local DNS 64, 66 and the DNS ALG 68. Pat's DNS entries are of the form:

Ying.ISPying.com NS=IPying_global

Art.ISPart.com NS=IPart_global.

This indicates that names ending in these components should be looked up in Ying's and Art's DNS servers 64, 66.

The entries in the DNS ALG 68 are of the form:

Ying.ISPying.com port=VPNpy

Art.ISPart.com port=VPNpa.

Accordingly, the queries for names ending in these components should be sent through the specified VPN tunnel 74. Ying and Art have analogous entries in their local DNS servers.

In the alternate embodiment, as shown in FIG. 4, Pat's DNS server 64 exchanges local device names and addresses with Ying's DNS server 66, either upon establishment of the tunnel 74 or by caching previous DNS query responses, and sets up the NAT 70, 72 address mappings. A particular advantage of such a configuration is that the look up process is speeded up. Note that the speed up is at the cost of memory and some additional protocol mechanisms.

Device PCpat 50 sends a message 104 querying the local DNS server 64 for the address of PCying.Ying.ISPying.com. The DNS server 64 matches this to Ying.ISPying.com and sends a query 106 to Ying's local DNS server 66 via the tunnel VPNpy 74 instead of to the public DNS 54. Because this query arrived through the VPN tunnel 74, Ying's DNS server 66 returns the local address:

PCying.Ying.ISPying.com A=Ipy_loc.

Pat's DNS_ALG 68 recognizes the response as having been delivered via the tunnel 74 and sends a request 110 to the NAT 70 to set up a mapping specific to the VPN tunnel 74. The NAT 70 returns a mapping, for example, in the form:

IPy_loc IPy_in_p VPNpy,

where IPy_in_p is an unused address in Pat's local address space. The DNS_ALG 68 then updates the response to:

PCying.Ying.ISPying.com A=IPy_in_p.

This is returned to PCpat 50.

Device PCpat 50 now initiates a session with PCying using the source address IPp_loc and destination IP address IPy_in_p using NAT 70. Note that there are no restrictions on either the source or the destination port numbers because there is no port translation. If IP packets (ignoring IP fields other than the addresses) are represented by the following format:

<Destination IP address> <Source IP address> <Payload>

then packets transmitted by PCpat have the form

<IPy_in_p> <IPp_loc> <payload>.

Pat's NAT 70 recognizes the mapping, replaces IPy_in_p with Ipy_loc, leaves IPp_loc unchanged, and sends a message 112 carrying the packet via the tunnel indicated, such as VPNpy 74 (i.e. the packet is encapsulated) to Ying's private network. These packets have the form:

<IPying_global> <IPpat_global> <IPy_loc> <IPp_loc> <payload>

and are routed in the public Internet 18 based on the outer IP headers.

At Ying's end of the tunnel 74, the packet is received and decapsulated. NAT 72 translates the source address and sets up a mapping in the form:

IPp_loc IPp_in_y VPNyp,

where IPp_in_y is an unused address in Ying's local address space. NAT 72 replaces the source address IPp_loc with IPp_in_y, and then forwards the packet normally within Ying's network to PCying. These packets have the form:

<Ipy_loc> <IPp_in_y> <payload>.

Once these NAT mappings have been established, packets can be exchanged between PCpat and PCying without creation of any additional states.

In a manner similar to the described above, other devices in Pat's home may connect to devices in Art's home, and devices in Ying's and Art's homes can communicate with those in Pat's home. It is to be understood that for security and privacy purposes, Pat's gateway must never forward a packet received on a VPN to another VPN. If Art sends a packet to Pat, the packet can be delivered to a system in Pat's home or dropped, but must not be forwarded to Ying. This does not preclude forwarding by applications, but prevents direct conversations between devices and in Ying's and Art's homes. Alternatively, if all the parties agree that forwarding and direct conversations are acceptable, an overlay network may be built on top of the tunnels (VPNs) to facilitate such functionality. It is also to be noted that firewall controls were left out of the above description for simplicity. For example, Pat may not want every device in his home to be accessible to Ying. As such, by using the firewall 40, selected devices and/or tunnels can be blocked off from access by other devices and tunnels.

It will be appreciated that other embodiments of the present invention include those mentioned below, as well as others. For example, another method for coordinating address spaces between sides of an established tunnel is for the RG in a first home to request addresses from the DHCP server in a second home on behalf of devices local to the first home. The RG in the first home can then translate addresses of its local devices into the remote second home's domain. Conflict resolution between the address given by the DHCP server in the second home and the used addresses in the first home is used to ensure proper address resolution. In addition, steps may be taken to ensure the RG in the first home is able to control its address re-use decisions.

Another method for coordinating address spaces is to do no NAT whatsoever between sides of a tunnel, and to coordinate address spaces in a more global manner. For example, DHCP servers on each side of a tunnel can coordinate to claim disjoint address spaces, and essentially enlarge the overall address space. In this situation, a first home connected via tunnels to second, third, and subsequent homes would coordinate disjoint spaces among all the homes. The address space is coordinated among the entire space of all connected homes to maintain routability.

It should be understood that the implementation of other variations and modifications of the invention in its various aspects will be apparent to those of ordinary skill in the art, and that the invention is not limited by the specific embodiments described. It is therefore contemplated to cover by the present invention, any and all modifications, variations, or equivalents that fall within the spirit and scope of the basic underlying principles disclosed and claimed herein.

What is claimed is:

1. A method for interconnecting multiple private networks in a publicly accessible network, comprising the steps of:
establishing a tunnel between a gateway of a first private network and a gateway of a second private network; and
mapping the address of a device in said first private network into the address space of said second private network at said second private network gateway for enabling the device in said first private network to communicate with said second private network.

2. The method of claim 1, further comprising the step of enabling the device in the private network to communicate with a device in the other private network.

3. The method of claim 1, further comprising the step of creating an entry in a name server local to the private network, the entry identifying a name of a device in the remote private network and assigning an IP address local to the private network.

4. The method of claim 1, further comprising the step of creating an entry in a name server application layer gateway local to the private network, the entry indicating the identity of the tunnel through which peer packets are to be transmitted.

5. The method of claim 1, further comprising the step of redirecting a public network configured query to the established tunnel.

6. The method of claim 5, further comprising the step of determining that a response to the query arrived through the tunnel.

7. The method of claim 6, further comprising the step of the name server returning the local address in response to the query.

8. The method of claim 1, wherein a packet is encapsulated using a predetermined format for enabling the packet to travel through the tunnel.

9. The method of claim 8, wherein the encapsulated packet comprises inner and outer headers.

10. The method of claim 9, wherein the outer header indicates the public network routing of the packet.

11. The method of claim 9, wherein the inner header indicates the private network routing of the packet.

12. A method for interconnecting multiple private networks, comprising the steps of:
assigning a fully qualified domain name to a gateway of each private network for enabling public access to the gateway;
assigning a local IP address to each device connected to the gateways, wherein each device is located in the private network;
establishing a tunnel between two or more of the private networks; and
creating a gateway address entry in each of the gateways for mapping the address of the devices for enabling each of the mapped devices in each of the networks to communicate with other mapped devices.

13. The method of claim 12 further comprising the step of encoding and decoding communications packets to enable the packets to be routed through the tunnel between the two or more private networks.

14. A gateway for interconnecting multiple private networks in a peer to peer networking relationship, comprising:
a name server for each private network for matching domain names to private IP addresses for devices connected in the private network;
a host configuration protocol server for administering IP addresses in the name server; and
an address translator for mapping an address space of the first private network into an address space of the second private network using the matched domain names for enabling mapped devices in each of the private networks to communicate with other mapped devices.

15. The gateway of claim 14 further comprising a firewall for preventing access to a mapped device from outside the network in which the mapped device is connected.

16. The gateway of claim 14 further comprising a tunnel through which data packets travel between the multiple private networks when the data packets are connected in a peer to peer configuration.

17. The gateway of claim 16 further comprising an application layer gateway for enabling the address translator to set up mapping corresponding to the identity of the tunnel for enabling data packets to travel through the tunnel.

18. The gateway of claim 17 further comprising an application layer gateway for preventing access to a mapped device from outside the network in which the mapped device is connected.

19. In a local gateway, a method for establishing a peer to peer connection with a remote peer gateway, the method comprising the steps of:
establishing a tunnel with the remote peer gateway;
mapping address space of the remote peer into the local address space of the local gateway;
providing mapped addresses on look-ups; and
routing a peer packet to the tunnel.

20. The method of claim 19, wherein the routing step further comprises the steps of:
coding the peer packet to enable the packet to be routed over the public network to the appropriate private network; and
decoding the peer packet to enable the packet to be routed to its destination within the private network.

21. The method of claim 20 wherein the decoding step comprises the step of replacing an original source address of the peer packet with a local source address.

22. The method of claim 19 wherein the peers have overlapping local address spaces.

23. The method of claim 19 wherein the mapping is uniquely routable within the joint network formed as the union of the two peer networks.

24. The method of claim 19 wherein the mapping maps addresses in the local address space to a unique pairing of an address routable on the remote network and a label corresponding to the tunnel over which packets travel.

25. The method of claim 19 wherein the tunnel is secure.

26. A method for interconnecting multiple private networks in a publicly accessible network, comprising the steps of:
establishing a tunnel between a gateway of a first private network and a gateway of a second private network;
establishing a tunnel between the gateway of the second private network and a gateway of third private network; and
configuring a name server in each of the private networks for enabling devices in each of the networks to access each other.

27. The method of claim 26, further comprising the step of selectively preventing a device in one of the networks from being accessed by a device in any of the other networks.

28. The method of claim 26, further comprising the step of selectively preventing a device in one of the networks from being accessed by any of the other networks.

29. The method of claim 26, further comprising the step of selectively preventing a device in one of the networks from being seen by any entity outside the network in which the device is located.

30. The method of claim 26, further comprising the step of establishing additional tunnels between additional private networks.

31. The method of claim 26, further comprising the step of selectively preventing a device in one of the networks from being seen by networks not authorized by the network containing the device.
